(19) United States
(12) Patent Application Publication
(10) Pub. No.: US 2025/0358352 A1
(43) Pub. Date: Nov. 20, 2025

(54) SMARTPHONE CASE WITH REAR-FACING VIEWFINDER DISPLAY

(71) Applicant: Irvin Joel Banta, Owens Cross Roads, AL (US)

(72) Inventor: Irvin Joel Banta, Owens Cross Roads, AL (US)

(21) Appl. No.: 19/209,800

(22) Filed: May 16, 2025

Related U.S. Application Data
(60) Provisional application No. 63/648,650, filed on May 16, 2024.

(51) Int. Cl. H04M 1/02; G06F 1/16; G06F 1/18; G06F 1/26; G06F 1/3212; G06F 1/3234

(52) U.S. Cl. CPC H04M 1/0203; G06F 1/1628; G06F 1/1629; G06F 1/182; G06F 1/184; G06F 1/188; G06F 1/189; G06F 1/266; G06F 1/3212; G06F 1/3265

(57) ABSTRACT

The present invention relates to a production-ready smartphone cases designed to enhance video content creation by utilizing advanced rear-camera technologies available in modern smartphones. The invention integrates a finalized, manufacturable electronics core comprising a precisely defined four-layer FR-4 printed circuit board (PCB) ready for high-volume production, a custom USB-C cable assembly supporting DisplayPort Alternate Mode, and an off-the-shelf 1.77-inch IPS LCD display module offering high brightness, contrast, and wide viewing angles. This integrated system provides a high-definition, low-latency live feed from the smartphone's superior rear camera, enabling optimal self-recording, vlogging, and live-streaming. Additionally, the modular design allows the same electronics core to seamlessly fit into multiple injection-molded smartphone-specific shells, thereby significantly enhancing manufacturability, reducing tooling complexity, and offering substantial practical improvements over existing solutions.

### CROSS-REFERENCE TO RELATED APPLICATIONS

This application claims the benefit of U.S. Provisional Patent Application No. 63/648,650, filed May 16, 2024, under 35 U.S.C. § 119(e), the contents of which are incorporated herein by reference in their entirety.

### BACKGROUND OF THE INVENTION

The present invention relates to smartphone accessories and, more particularly, to protective cases that incorporate an integrated rear-facing display driven via USB-C DisplayPort Alternate Mode to operate as a live viewfinder for the smartphone's rear cameras.

### DESCRIPTION OF RELATED ART

Smartphone cases incorporating secondary displays are known. Representative examples include covers that display notifications or other information (U.S. Pat. No. 10,498,870 B2), cases with customizable or decorative rear screens (US 2023/0297138 A1), flexible or extension-display housings (KR 101512364 B1; JP 6407206 B2), cases with detachable or aesthetic LCD modules (U.S. D 879,761 S1), and battery cases that accommodate additional display devices (U.S. Pat. No. 10,452,105 B2; U.S. D 721,687 S1). While these references expand screen real estate or enhance device aesthetics, none address the challenge of providing a real-time rear-facing viewfinder that leverages the superior imaging capabilities of the smartphone's rear camera for self-recording. Accordingly, a need exists for a protective smartphone case that offers such functionality while maintaining compatibility with standard USB-C interfaces.

### SUMMARY OF THE INVENTION

In one aspect, the invention provides a smartphone case comprising an integrated electronic system, including a multi-layer printed circuit board (PCB), a rechargeable battery, and a custom USB-C cable assembly compatible with DisplayPort Alternate Mode. This system also features a compact IPS LCD display module for real-time video viewing, facilitating ease of manufacturing and adaptability across various injection-molded case shells specifically tailored to different smartphone models.

Leveraging standard USB-C negotiation allows automatic setup of DisplayPort Alternate Mode, providing users with instant plug-and-play functionality. The low latency and high refresh rate of the integrated display greatly enhance usability, particularly beneficial during live content creation or video blogging.

By utilizing the smartphone's rear camera instead of the front-facing camera, the invention significantly improves video quality and user experience, simplifying the workflow for digital content creators who typically require complex setups to achieve professional-quality video.

In preferred embodiments, a single standardized electronics sub-assembly—including a display, USB-C Alt-Mode interface, PCB, and rechargeable power source—is integrated into each of a plurality of smartphone-specific protective housings. This design enables the same electronics sub-assembly to be efficiently mass-produced and integrated into multiple phone-specific case models, with only the external plastic housing molds varying between smartphone models.

Collectively, these inventive features significantly enhance user capability for digital content creation, particularly benefiting vloggers, live-streamers, and professional content producers by streamlining content framing, improving recording quality, and providing an integrated, user-friendly solution. By strategically leveraging the superior optics and capabilities of the rear camera through a conveniently placed secondary display, the invention offers a unique, non-obvious solution specifically tailored to meet the needs of digital content creators, clearly distinguishing itself from existing technologies in the field.

### BRIEF DESCRIPTIONS OF DRAWINGS

FIG. 1A is a rear-facing view of a smartphone case with a rear-facing viewfinder display.

FIG. 1B is a rear-facing view of the smartphone case, illustrating a protective rim around the viewfinder display and button overlays.

FIG. 1C is a rear-facing view of the smartphone case highlighting additional access ports and control interfaces.

FIG. 1D is a rear-facing view of the smartphone case, showing the USB-C port opening and protective features around the display.

FIG. 1E is a simplified rear-facing view of the smartphone case.

FIG. 2A is a profile view of the smartphone case showing the overall side geometry and locations of button overlays and mute switch access.

FIG. 2B is a profile view of the smartphone case demonstrating the thickness and layered structure accommodating internal components.

FIG. 2C is a top view of the smartphone case.

FIG. 2D is a bottom view of the smartphone case showing the USB-C interface alignment.

FIG. 3A is a front-facing view of the smartphone case illustrating front-side openings and internal shielding structure.

FIG. 3B is a perspective front-facing view of the smartphone case demonstrating external features and component positioning.

FIG. 3C is an alternate front-facing perspective view showing ergonomic layout and button placements.

FIG. 4A is a top-down interior view of the lower shell of the smartphone case with electronic components installed, including display, battery, and PCB.

FIG. 4B is an exploded view of the internal electronics assembly illustrating display, battery, ribbon cables, and circuit board components, emphasizing modularity.

FIG. 4C is an interior view of two alternate phone-specific housings, illustrating standardized receptacle features for receiving the removable electronics module.

FIG. 5A is an inside view of the upper shell (top cover) of the smartphone case, showing non-electronic structural elements and their alignment features.

FIG. 6 is a block diagram of the electronic architecture configured to receive a DisplayPort Alternate Mode signal from a smartphone host and render video to a display module, including power management and optional logic blocks.

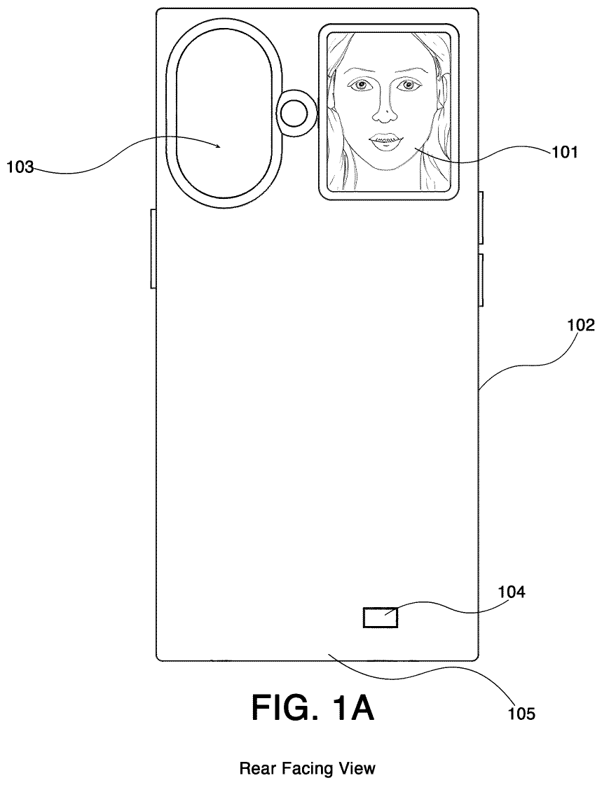

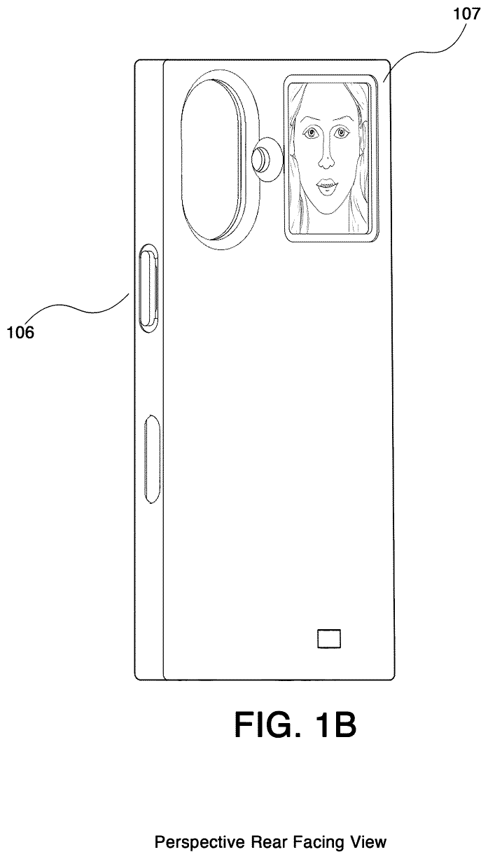

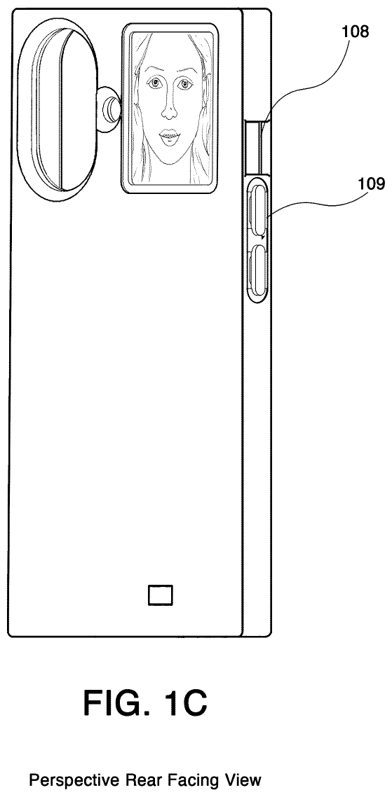

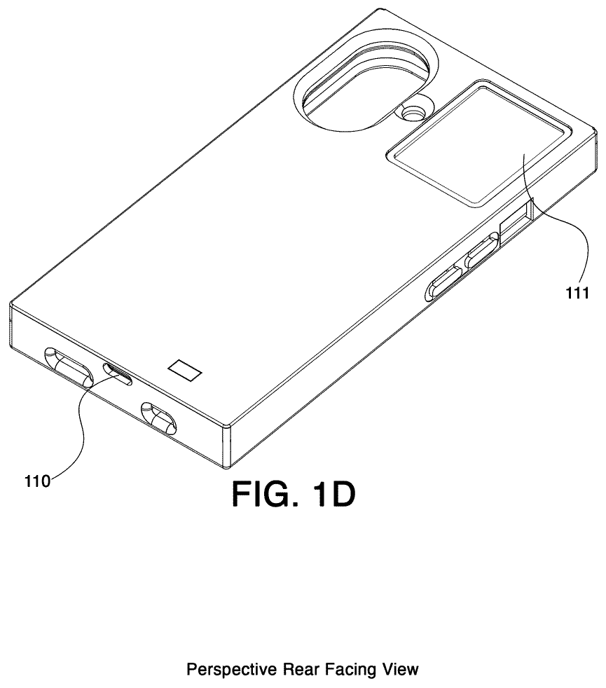

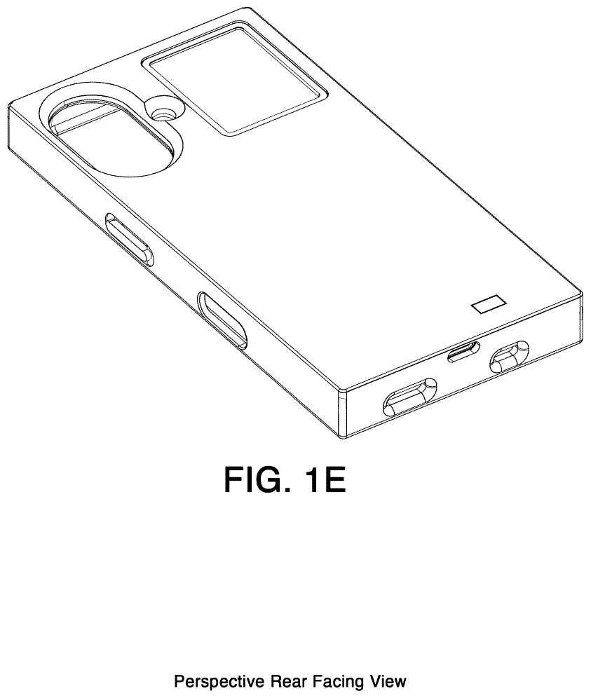

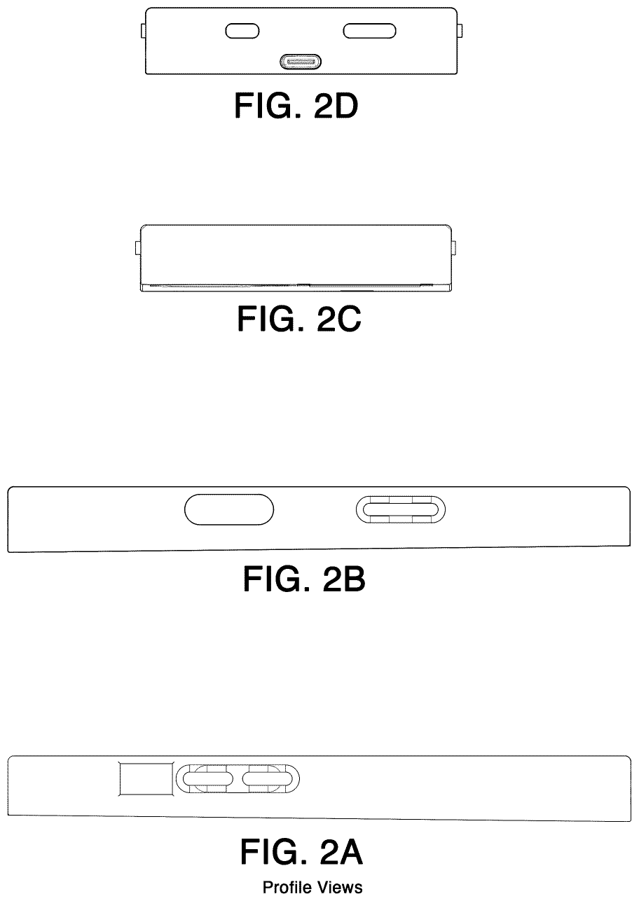

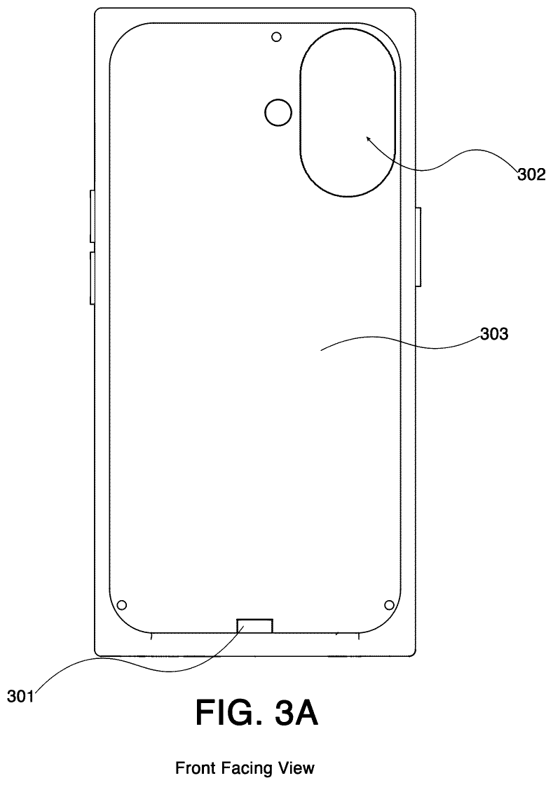

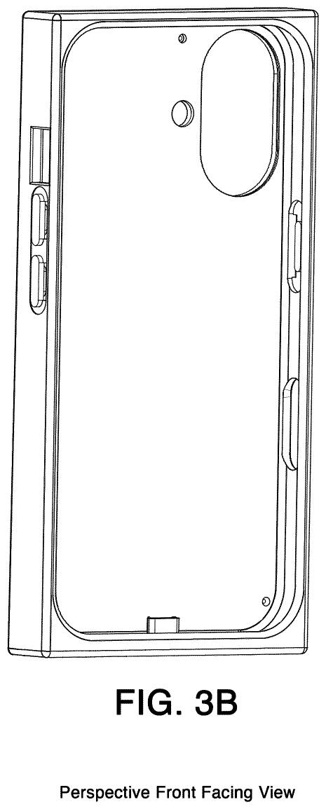

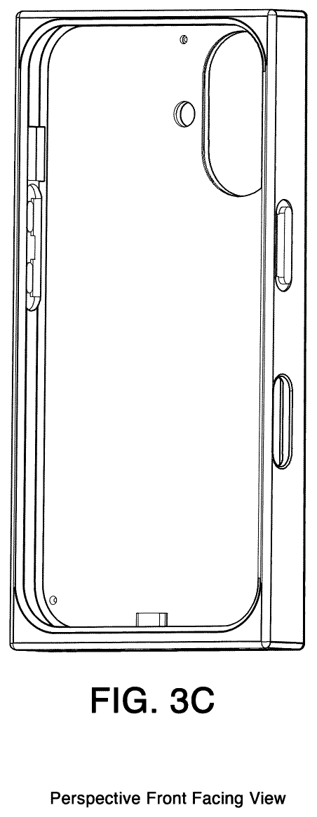

### DETAILED DESCRIPTION OF THE INVENTION

The present invention comprises a smartphone case (102) integrated with a rear-facing electronic viewfinder display (101). The core structural components include a custom-designed printed circuit board (PCB), a low-latency IPS display module, and precisely engineered mechanical housing adapted to securely fit around a smartphone device. This PCB interfaces directly with the smartphone via a USB-C connector (105) that supports DisplayPort Alternate Mode (Alt Mode) to facilitate real-time, high-definition video display from the smartphone's rear camera system.

The smartphone case body (102) is preferably constructed from injection-molded polycarbonate or similar durable, lightweight materials. The housing securely accommodates the smartphone, providing a rear camera opening (103) aligned precisely with the smartphone's camera module, speakers, microphones, and charging ports. Additional internal ribs or spacers (303) are strategically located within the case to secure and protect internal components and ensure reliable structural integrity under typical usage conditions.

### PCB Stack-Up and Electronics

The PCB incorporates multiple functional layers arranged to optimize electrical performance, thermal management, and mechanical durability.

Electronic components on the PCB include a USB-C receptacle, DisplayPort-to-MIPI display bridge integrated circuit (IC), voltage regulators, decoupling capacitors, and impedance-matched high-speed signal traces. The PCB (404) is fabricated in accordance with industry-standard impedance-controlled routing rules, ensuring optimal signal integrity and minimal latency in video signal transmission. Flexible ribbon cables (401) connect the PCB to the display module and the USB-C port, facilitating efficient internal wiring and assembly.

### Display Module and Protective Features

The integrated rear-facing display (101, 402) is a compact IPS (In-Plane Switching) LCD panel, selected for optimal resolution, viewing angle, power consumption, and minimal latency performance. IPS technology providing wide viewing angles essential for clear visibility during handheld filming positions.

The display module (402) is seated within a recessed area of the smartphone case, surrounded by an extruded plastic rim (107) designed to enhance durability and safeguard against impacts. Additionally, a protective layer (111) overlays the display surface to mitigate scratches and enhance overall durability.

### Housing and Operational Interface

The case housing includes user-accessible control elements strategically positioned for intuitive operation. A dedicated power button (104) is located on the side of the case, activating the rear-facing display and associated electronic components. Overlay buttons for phone power (106) and volume controls (109) extend the underlying functionality of the smartphone's native buttons, ensuring ease of access through the protective casing. A mute slider opening (108) allows users to maintain functionality of the smartphone's native mute control without compromising the protective integrity of the case.

The case further provides a precisely positioned camera cutout (302) at the top, designed to align exactly with the smartphone's rear camera, ensuring unobstructed image and video capture. Additionally, the case integrates a USB-C connector (105) at its bottom, aligned precisely via the PCB board interface with the smartphone's native USB-C port. An additional USB-C port opening (110, 301) at the bottom of the case facilitates external cable connections for simultaneous charging of both smartphone and internal battery components, prioritizing smartphone charging before charging the integrated battery that powers the viewfinder display.

### Internal Components and Assembly

Assembly involves positioning the PCB, battery module (403), and display module (402) within specifically designed compartments formed inside the molded housing. Components are secured using methods such as mechanical fasteners, clips, adhesive tapes, or ultrasonic welding as manufacturing considerations dictate. The battery module (403) is seated securely within a lower cavity, beneath a protective plate and shield (303) lined with a soft backing to ensure protection and structural integrity.

### Standardized Electronics Sub-Assembly

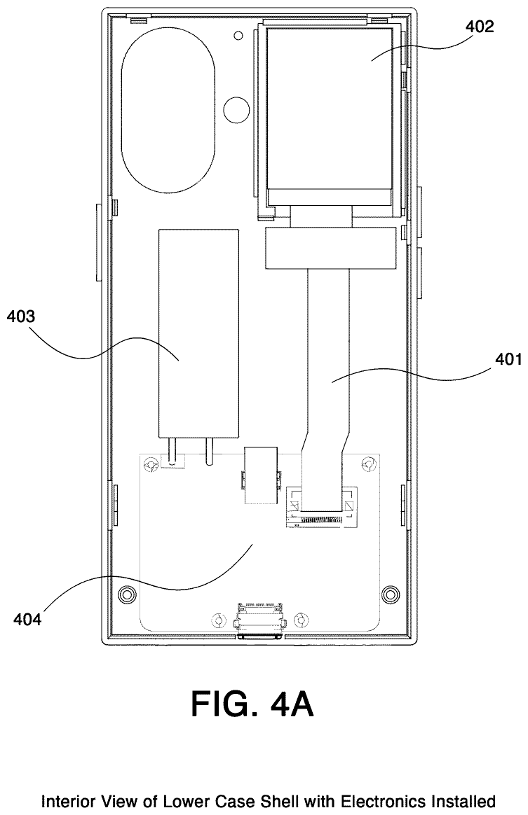

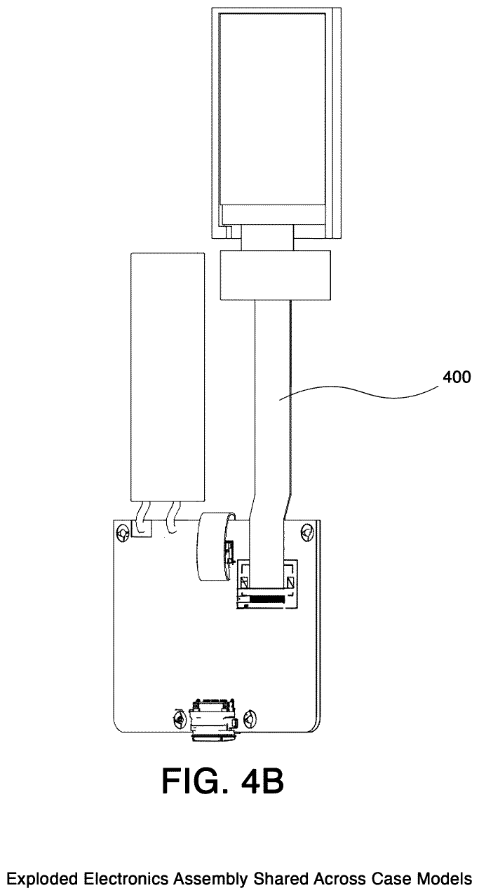

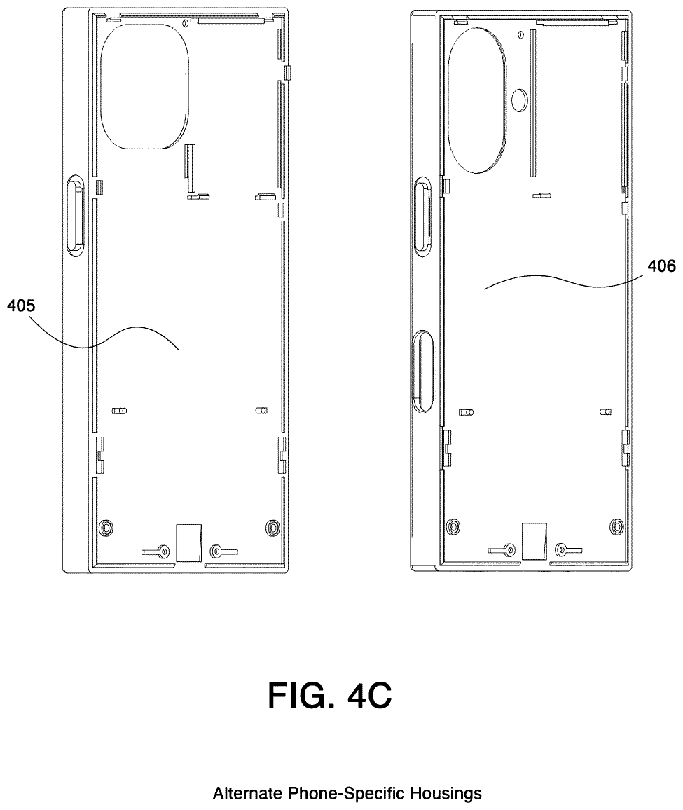

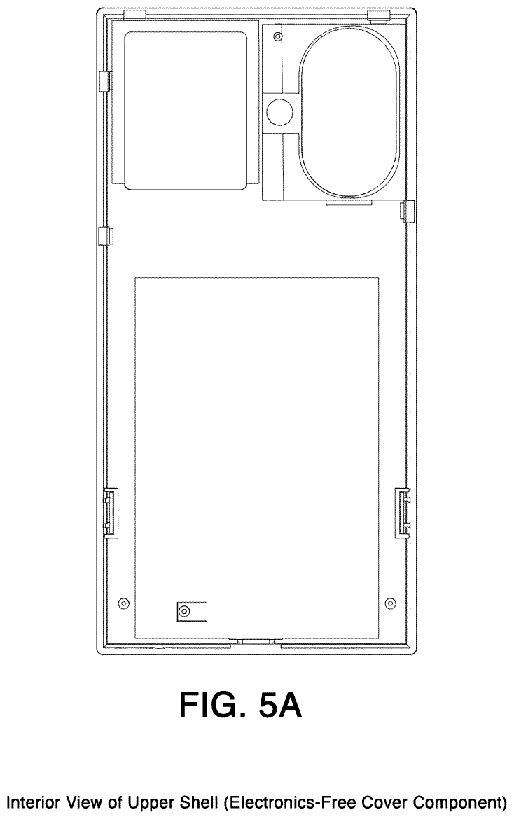

FIG. 4B illustrates a standardized electronics sub-assembly (400) integrated within each smartphone-specific protective housing. This electronics sub-assembly (400) includes: a rear-facing display module (402); a printed circuit board (PCB) assembly (404) carrying critical electronic components, including a DisplayPort-to-MIPI bridge integrated circuit (IC), power-management circuits, and USB-C receptacle capable of DisplayPort Alternate Mode (Alt Mode); a battery or power-storage module (403); internal ribbon-cable interconnections (401). The electronics sub-assembly (400) is dimensionally and electrically standardized, allowing it to be integrated consistently across multiple smartphone-specific housings (405, 406). Each housing is distinct in geometry, tailored specifically to individual smartphone models, differing only in external shape, camera module openings, speaker apertures, and control access ports. However, each housing shares identical internal mounting interfaces to accommodate the standardized electronics sub-assembly (400), thus streamlining manufacturing processes, tooling requirements, and inventory management.

### Operation

Operationally, upon connecting the case to a smartphone via USB-C, the system automatically detects DisplayPort Alternate Mode signals and activates the rear-facing viewfinder display (101). Users see a real-time preview streamed directly from the smartphone's high-quality rear camera, enabling precise content framing without additional equipment. The system utilizes low-latency technology, providing minimal delay between actual events and their visual representation, essential for video recording applications such as vlogging and live-streaming.

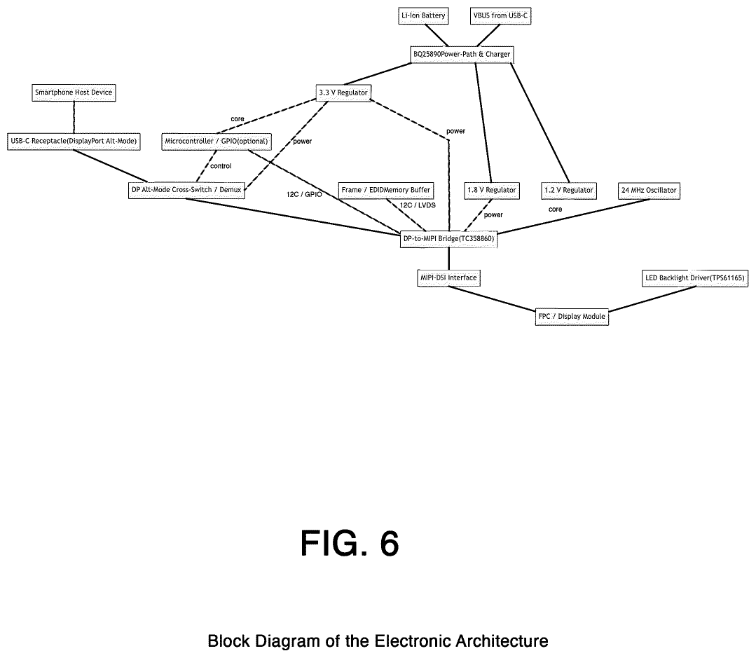

### Electronic Architecture (FIG. 6)

FIG. 6 illustrates the detailed electronic architecture of the invention configured to receive a DisplayPort Alternate Mode signal from a smartphone host device (10) via a USB-C receptacle (20). The received high-speed video signals are routed through a signal switch (30) into a protocol bridge IC (40), converting the DisplayPort stream into a compact display-compatible format (MIPI-DSI) transmitted to the integrated display module (60). The architecture supports dual-source power, with a rechargeable battery (70) and external VBUS input (72) supplying energy managed by the power management subsystem (80) and voltage regulators (90a, 90b, 90c), ensuring continuous operation and minimal power consumption. Additional components include an LED backlight driver (100), oscillator (110), optional control logic (120), and optional storage elements (130) for future enhancements and firmware updates.

What is claimed is:

1. A protective case for a smartphone comprising: a housing adapted to encase the smartphone, the smartphone having at least one rear-facing camera and a USB-C port that supports DisplayPort Alternate Mode; a secondary display mounted on the housing adjacent to the rear-facing camera; and an electrical interface disposed within the housing and operatively coupled between the USB-C port and the secondary display so that a live video signal from the rear-facing camera is conveyed to the secondary display to provide a real-time viewfinder image for the user.

2. The protective case of claim 1, wherein the secondary display is recessed in the housing such that its viewing surface is flush with or below an exterior protective rim surrounding the display.

3. The protective case of claim 1, further comprising a signal-processing circuit configured to convert DisplayPort Alternate Mode signals into MIPI-DSI signals and to present the video on the secondary display with an end-to-end latency of less than 50 milliseconds.

4. The protective case of claim 1, wherein the secondary display is configured to automatically activate in response to detection that a camera application is executing on the smartphone, and to enter a low-power standby state when the camera application is not active.

5. The protective case of claim 1, wherein the housing further includes an interior rechargeable battery electrically coupled to the secondary display and configured to supply power when the smartphone battery falls below a threshold state-of-charge.

6. The protective case of claim 1, wherein the dual-layer housing provides a rigid anchor point for internal electronics and a compliant fit profile that enables USB-C alignment when the smartphone is inserted.

7. The protective case of claim 1, further comprising an internal rechargeable battery and a power-management subsystem operatively connected to selectively supply power to the secondary display from either the smartphone via a USB interface or the internal battery based upon detected operating conditions.

8. The protective case of claim 1, wherein the electrical interface includes a protocol-conversion circuit configured to convert video signals received from the smartphone's USB interface into a display-compatible format for driving the secondary display.

9. The protective case of claim 1, wherein the electrical interface further comprises high-speed signal conditioning circuitry configured to maintain signal integrity for high-speed digital communication between the smartphone and the secondary display.

10. The protective case of claim 1, wherein the secondary display comprises a graphical display panel with characteristics optimized for clear visibility under various ambient lighting conditions and viewing angles typical of handheld operation.

11. The protective case of claim 1, wherein the housing structure is configured to accept and securely retain an electronics core assembly, wherein the electronics core assembly has standardized mounting interfaces that enable compatibility with multiple smartphone case designs differing primarily in smartphone-specific geometric features.

12. An electronics subassembly configured for integration within smartphone-protective housings, comprising: a printed-circuit board including circuitry configured to convert video signals received from a smartphone via a standard communication interface into signals suitable for driving an integrated display; a cable assembly terminating in a standardized connector configured to couple with a smartphone communication port; an integrated graphical display module operatively coupled to the printed-circuit board to receive and display the converted video signals; an internal power source with associated power-management circuitry configured to selectively power the display module in the absence of external power from the smartphone; and a microcontroller programmed to monitor an operational status of a camera application executing on the smartphone, activate the display module when the camera application is detected as active, and return the display to standby when the camera application is detected as inactive; wherein the printed-circuit board and mechanical mounting interfaces are standardized such that the same sub-assembly is installable in each of a plurality of distinct smartphone-specific housings whose external geometries differ to accommodate respective smartphone models.

13. A method of operating a protective smartphone case having an integrated secondary display, comprising: establishing an electrical connection between the protective case and a smartphone through a standard wired interface; negotiating a video transmission mode via the wired interface; receiving real-time video data originating from at least one camera of the smartphone; converting the received video data into a format compatible with the secondary display; displaying the converted video data on the secondary display with sufficiently low latency to serve as a real-time viewfinder for the smartphone's camera; monitoring an operational status of a camera application executing on the smartphone; automatically activating the secondary display from a standby state when the camera application is detected as active; and returning the secondary display to the standby state when the camera application is detected as inactive.

14. The method of claim 13, further comprising charging a battery inside the case from VBUS power when the smartphone battery state-of-charge exceeds a threshold.

15. The method of claim 13, wherein step (d) includes switching high-speed differential pairs through a signal switch and redriver circuitry to maintain signal integrity at 10 Gb/s.
